(19) United States
(12) Patent Application Publication
(10) Pub. No.: US 2019/0288811 A1
(43) Pub. Date: Sep. 19, 2019

(54) COVERAGE ENHANCEMENT FOR UNLICENSED INTERNET OF THINGS (U-IOT)

(71) Applicant: INTEL IP CORPORATION, Santa Clara, CA (US)

(72) Inventors: Wenting Chang, Beijing (CN); Huaning Niu, San Jose, CA (US); Qiaoyang Ye, San Jose, CA (US); Jeongho Jeon, San Jose, CA (US)

(21) Appl. No.: 16/349,963

(22) PCT Filed: Nov. 15, 2017
(86) PCT No.: PCT/US17/61873

§ 371 Date: May 14, 2019

Related U.S. Application Data
(60) Provisional application No. 62/423,039, filed on Nov. 16, 2016.

(51) Int. Cl. H04L 5/00; H04W 72/04

(52) U.S. Cl. CPC H04L 5/0044; H04W 72/04; H04W 72/042

(57) ABSTRACT

Technology for a next generation node B (gNB) operable to provide coverage enhancement for unlicensed internet of of things (IoT) is disclosed. The gNB can encode, for transmission on a physical downlink shared channel (PDSCH), data in a selected subframe. The gNB can encode, for transmission to a user equipment (UE), a number of repetitions in time, a value of Ni, for the data to be transmitted on the PDSCH, wherein the value of N₁ is a positive integer value. The gNB can encode the data on N₁ consecutive subframes for repeated transmission of the data in the selected subframe to the UE. The gNB can include a memory interface configured to receive from a memory the data in the selected subframe.

### BACKGROUND

Wireless systems typically include multiple User Equipment (UE) devices communicatively coupled to one or more Base Stations (BS). The one or more BSs may be Long Term Evolved (LTE) evolved NodeBs (eNB) or new radio (NR) NodeBs (gNB) or next generation node Bs (gNB) that can be communicatively coupled to one or more UEs by a Third-Generation Partnership Project (3GPP) network.

Next generation wireless communication systems are expected to be a unified network/system that is targeted to meet vastly different and sometimes conflicting performance dimensions and services. New Radio Access Technology (RAT) is expected to support a broad range of use cases including Enhanced Mobile Broadband (eMBB), Massive Machine Type Communication (mMTC), Mission Critical Machine Type Communication (uMTC), and similar service types operating in frequency ranges up to 100 GHz. A target user equipment (UE) can be located in the deepest corner of a building which can affect the functionality. This can be true when the UE is being used for Internet of Things (IoT) applications. When the UE is located in the deepest corner of the building, the link quality of the physical downlink shared channel (PDSCH) can be degraded.

### BRIEF DESCRIPTION OF THE DRAWINGS

Features and advantages of the disclosure will be apparent from the detailed description which follows, taken in conjunction with the accompanying drawings, which together illustrate, by way of example, features of the disclosure; and, wherein:

FIG. 1 illustrates a power boosting scheme to enhance coverage for unlicensed internet of things (U-IoT) in accordance with an example;

FIG. 2 illustrates frequency domain repetition to enhance coverage for U-IoT in accordance with an example;

FIG. 3a illustrates time domain repetition to enhance coverage for U-IoT in accordance with an example;

FIG. 3b illustrates time domain repetition to enhance coverage for U-IoT in accordance with an example;

FIG. 3c illustrates time domain repetition to enhance coverage for U-IoT in accordance with an example;

FIG. 4 depicts functionality of a next generation node B (gNB) operable to provide coverage enhancement for U-IoT in accordance with an example;

FIG. 5 depicts functionality of a user equipment (UE) operable to provide coverage enhancement for U-IoT in accordance with an example;

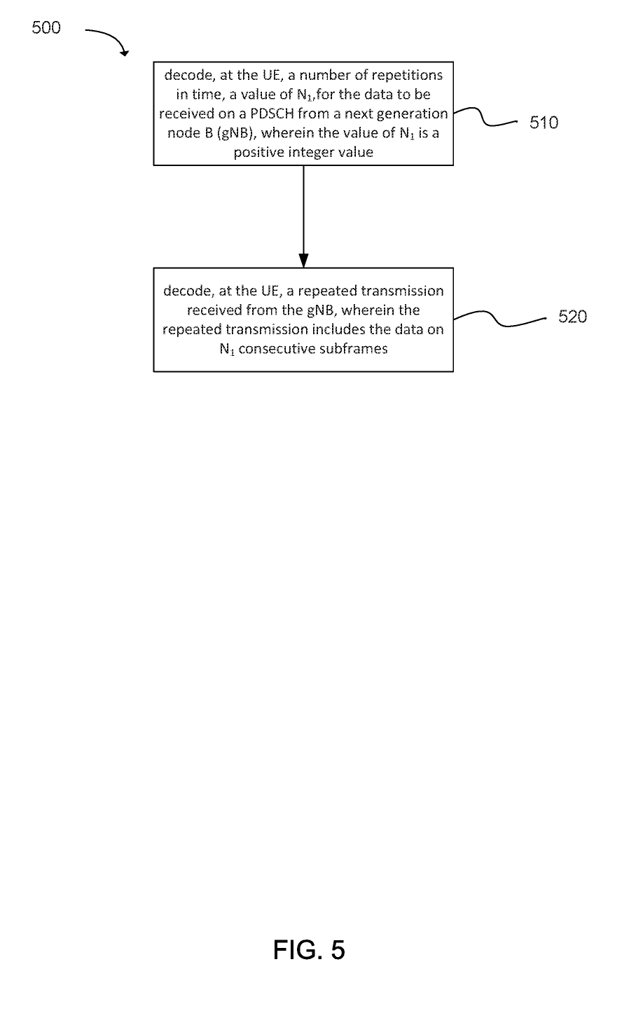

FIG. 6 depicts a flowchart of a machine readable storage medium having instructions embodied thereon for providing coverage enhancement for U-IoT in accordance with an example;

FIG. 7 illustrates an architecture of a wireless network in accordance with an example;

FIG. 8 illustrates a diagram of a wireless device (e.g., UE) in accordance with an example;

FIG. 9 illustrates interfaces of baseband circuitry in accordance with an example; and

FIG. 10 illustrates a diagram of a wireless device (e.g., UE) in accordance with an example.

Reference will now be made to the exemplary embodiments illustrated, and specific language will be used herein to describe the same. It will nevertheless be understood that no limitation of the scope of the technology is thereby intended.

### DETAILED DESCRIPTION

Before the present technology is disclosed and described, it is to be understood that this technology is not limited to the particular structures, process actions, or materials disclosed herein, but is extended to equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating actions and operations and do not necessarily indicate a particular order or sequence.

### Example Embodiments

An initial overview of technology embodiments is provided below and then specific technology embodiments are described in further detail later. This initial summary is intended to aid readers in understanding the technology more quickly but is not intended to identify key features or essential features of the technology nor is it intended to limit the scope of the claimed subject matter.

The explosive growth in wireless traffic has led to a demand for rate improvement. However, with mature physical layer techniques, further improvement in spectral efficiency has been marginal. In addition, the scarcity of licensed spectrum in the low frequency band results in a deficit in the data rate boost. There are emerging interests in the operation of LTE systems in unlicensed spectrum. In 3GPP LTE Release 13, one enhancement has been to enable operation in the unlicensed spectrum via licensed-assisted access (LAA). LAA can expand the system bandwidth by utilizing a flexible carrier aggregation (CA) framework, as introduced in the LTE-Advanced system (3GPP LTE Release 10 system). Release 13 LAA focuses on the downlink (DL) design, while 3GPP Release14 enhanced LAA (or eLAA) focuses on the uplink (UL) design. Enhanced operation of LTE systems in the unlicensed spectrum is expected in Fifth Generation (5G) wireless communication systems. In one example, LTE operation in the unlicensed spectrum can be achieved using dual connectivity (DC) based LAA. In DC based LAA, an anchor deployed in the licensed spectrum can be utilized.

In another example, 3GPP Release 14 describes that LTE operation in the unlicensed system can be achieved using a MuLTEfire system, which does not utilize an anchor in the licensed spectrum. The MuLTEfire system is a standalone LTE system that operates in the unlicensed spectrum, and does not necessitate assistance from the licensed spectrum and combines the performance benefits of LTE technology with the simplicity of WiFi-like deployments. Therefore, Release 14 eLAA and MuLTEfire systems can potentially be significant evolutions in future wireless networks.

In one example, the unlicensed frequency band of current interest for 3GPP systems is the 5 gigahertz (GHz) band, which has wide spectrum with global common availability. The 5 GHz band in the United States is governed using Unlicensed National Information Infrastructure (U-NII) rules by the Federal Communications Commission (FCC). The main incumbent system in the 5 GHz band is the wireless local area networks (WLAN), specifically those based on the IEEE 802.11 a/n/ac technologies. WLAN systems are widely deployed both by individuals and operators for carrier-grade access service and data offloading. Therefore, listen-before-talk (LBT) in the unlicensed spectrum is a mandatory feature in the 3GPP Release 13 LAA system, which can enable fair coexistence with the incumbent system. LBT is a procedure in which radio transmitters first sense the medium, and transmit only if the medium is sensed to be idle.

The regulations for usage of the unlicensed spectrum can vary based on region. For example, the European Telecommunications Standards Institute (ETSI) in the European Union specifies that an occupied channel bandwidth (OCB) is to be between 80% and 100% of a declared nominal channel bandwidth. In other words, a transmitter is to transmit a signal by occupying between 80% and 100% of the system bandwidth. For example, when the system operates with a total bandwidth of 10 MHz, each transmission is to occupy at least 8 MHz. The regulations on the maximum power spectral density are typically stated with a resolution bandwidth of 1 megahertz (MHz). The ETSI specification defines a maximum power spectral density (PSD) of 10 decibel-milliwatts (dBm)/MHz for 5150-5350 MHz. The FCC has a maximum PSD of 11 dBm/MHz for 5150-5350 MHz. A 10 kilohertz (KHz) resolution can be utilized for testing the 1 MHz PSD constraint and, therefore, the maximum PSD constraint can be satisfied in an occupied 1MHz bandwidth. In addition, the regulations impose a band specific total maximum transmission power in terms of equivalent isotropically radiated power (EIRP), e.g., ESTI has an EIRP limit of 23 dBm for 5150-5350 MHz.

A target user equipment (UE) can be located in the deepest corner of a building which can affect the functionality. This can be true when the UE is being used for IoT applications. When the UE is located in the deepest corner of the building, the link quality of the MuLTEfire system can be lower than desired. In particular, the link quality of the physical downlink shared channel (PDSCH) can be lower than desired. Enhancing or extending the coverage of a cell can not only enhance the link quality of the PDSCH but also reduce the number of gNBs that are deployed, which can reduce the deployment cost.

There are various ways of enhancing the link quality of MuLTEfire systems to enlarge the coverage area for unlicensed internet of things (U-IoT) applications. IOT communication devices can be configured for low power wireless communication to enable the IOT devices to operate for a substantial period of time using a battery, such as a button battery, to power a cellular IOT transceiver. In one example, a typical button battery can power an IOT device for a period of several years, up to and including 5 years. Due to the extremely large number of IOT devices that will coexist in the future, the use of unlicensed spectrum can be advantageous to provide sufficient spectrum for the IOT devices to communicate effectively.

Various mechanisms can be used to improve communication of IOT devices in unlicensed spectrum. For example, the link quality of the PDSCH can be enhanced by power boosting, repetition in the frequency domain, repetition in the time domain, using a revised Modulation and Coding Scheme (MCS) table, and channel selection. These five ways of enhancing the coverage area for U-IoT application can be used in any combination with each other.

### Power Boosting

The link quality of the physical downlink shared channel (PDSCH) can be enhanced in various ways. One way of enhancing the link quality of the PDSCH, and enlarging the coverage area for internet of things (IoT) application, is through the use of power boosting.

In one example, within the assigned resource blocks (RBs) for an IOT communication, the data can be transmitted on partial resource blocks, in which the power of vacant RBs can be used to boost the power of valid RBs. A valid RB is an RB that data can be transmitted on. A vacant RB is an RB that data is not transmitted on. An assigned RB is the collection of RBs that will be transmitted. A narrow band transmission can also lower the noise bandwidth, which can increase the signal-to-interference plus noise ratio at a receiver.

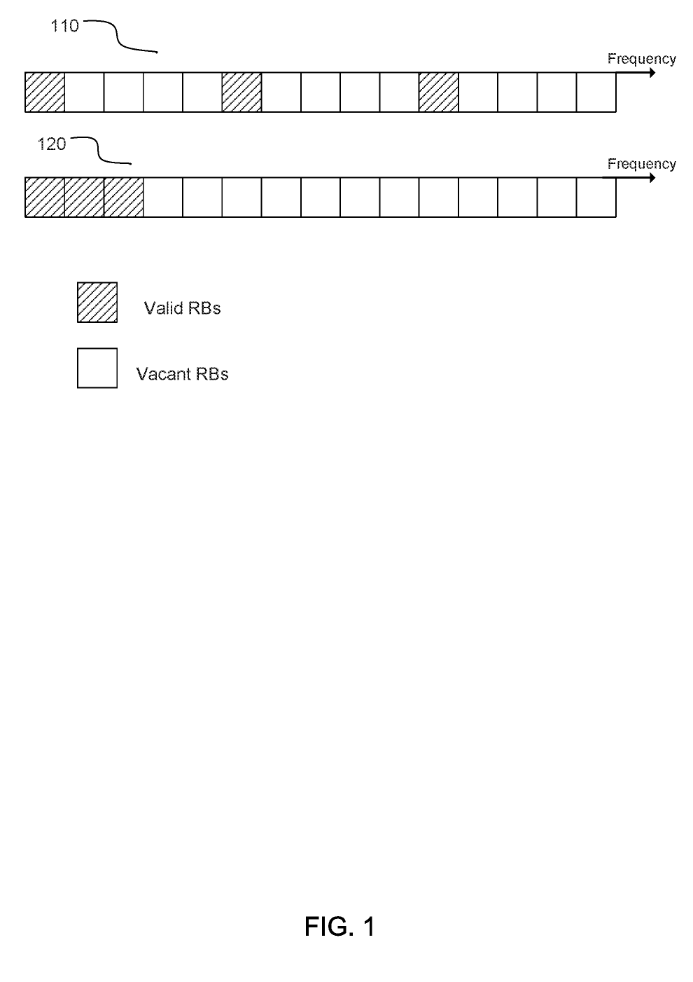

In one example, as illustrated in FIG. 1, the valid RBs and vacant RBs can occupy the assigned RBs in a distributed or localized scheme. In 110, the physical resource blocks (PRBs) occupation of the assigned RBs is distributed. The valid RBs can repeat once for every 5 RBs, as shown in 110, or the valid RBs can repeat at a different integer rate. The rate of repetition can be selected to enhance the coverage of the PDSCH. The vacant RBs can occupy the assigned RBs between the valid RBs. In 110, the vacant RBs occupy the four RBs between the valid RBs. In 110, the left-most RB is valid. Moving rightward, the next four RBs are vacant. This pattern can repeat until all of the assigned RBs have been occupied. Positioning the RBs in this distributed scheme can result in potential frequency diversity gain. This can allow the vacant RBs to boost the power of the valid RBs by leveraging the vacant RBs to the valid RBs. As mentioned, this can also lower the noise bandwidth.

In another example, the valid RBs can occupy the assigned RBs in a localized scheme. This can result in high channel estimation accuracy because of physical resource block (PRB) bundling. With PRB bundling, the UE can assume that the level of granularity is multiple RBs, but the UE can still perform single RB channel estimation. This can improve the channel estimation accuracy, and can result in a reduced sampling rate after filtering.

As shown in 120, there can be three valid RBs occupying three consecutive RBs. These valid RBs can be followed by twelve vacant RBs. The number of consecutive RBs can vary and the number of vacant RBs can vary. Both the number of valid RBs and the number of vacant RBs can be selected to enhance the coverage of the PDSCH.

In another example, the RBs can occupy the assigned RBs in a distributed and a localized scheme. Groups of localized RBs can be distributed in the frequency band. For example, a group of three RBs can be repeated every 6 RBs. The number of RBs that can be grouped and the number vacant RBs in between the grouped RBs can be selected to enhance the coverage of the PDSCH.

In another example, the ratio of valid RBs within the assigned RBs can be dynamically configured by downlink control information (DCI) or semi-statically configured via higher layer signaling, such as radio resource control (RRC) signaling.

In one example, a two-bit indicator can be utilized to indicate the ratio of valid RBs to total RBs. The bits “00” can represent a ratio of 1 or a percentage of 100% in which all of the assigned RBs are valid RBs. The bits “01” can represent a ratio of ½ or a percentage of 50% in which half of the assigned RBs are valid RBs. In some embodiments, a ratio of ½ can provide 3 decibels (dB) of power boosting. The bits “10” can represent a ratio of 4 or a percentage of 25% in which a quarter of the assigned RBs are valid RBs. In some embodiments, a ratio of 4 can provide 6 dB of power boosting. The bits “11” can represent a ratio of 8 or a percentage of 12.5% in which one eighth of the assigned RBs are valid RBs. In some embodiments, a ratio of 8 can provide 9 dB of power boosting.

In another example, the two-bit indicator can be utilized to indicate other ratios of valid RBs to total RBs. The bits “00” can represent that 100% of the assigned RBs are valid RBs. The bits “01” can represent that 20% or ⅕ of the assigned RBs are valid RBs. The bits “10” can represent that 40% or ⅖ of the assigned RBs are valid RBs. The bits “11” can represent that 60% or ⅗ of the assigned RBs are valid RBs. The two-bit indicator can be utilized to represent different percentages and ratios of valid RBs to total RBs.

In another example, the RB shift can be selected to avoid inter-cell interference. The RB shift can be configured through physical layer signaling, such as DCI, or higher layer signaling, such as RRC signaling. Different cells can be assigned a different RB shift to avoid inter-cell interference. The RB shift can be either cell specific or UE specific.

In one example, a three-bit indicator can be used to indicate the RB shift. The bits “000” can indicate an RB shift of 0. The bits “001” can indicate an RB shift of 1. The bits “010” can indicate an RB shift of 2. The bits “011” can indicate an RB shift of 3. The bits “100” can indicate an RB shift of 4. The bits “101” can indicate an RB shift of 5. The bits “110” can indicate an RB shift of 6. The bits “111” can indicate an RB shift of 7.

In one example, the assigned RBs can be assigned in a compact scheme to reduce the necessary field for resource allocation. If the total number of RBs is N_{RB}, wherein N_{RB} is an integer greater than or equal to 1, and the ratio of valid RBs is α, wherein α is a real number between 0 and 1, then a gNB can assigned the RBs in a compact scheme within the range of [0 1 . . . [α*NRB]]. For example, if the total number of RBs is 10 and if the ratio of valid RBs to total number of RBs is ½, then the range of the compact scheme can be [0, 1, 2, 3, 4, 5].

In another example, within one RB, data can be transmitted on partial subcarriers. A valid subcarrier is a subcarrier that transmits data and a vacant subcarrier is a subcarrier that does not transmit data. The power of vacant subcarriers can be used to boost the power of valid subcarriers by leveraging the vacant subcarriers to the valid subcarriers, where the ratio of valid subcarriers, and the offset between the cell-specific reference signal (CRS) and valid subcarriers can be pre-defined or configured by the gNB via higher layer signaling, such as RRC signaling.

In another example, the valid RBs of the assigned RBs can be frequency hopped over multiple subframes. This can result in additional frequency diversity gain in comparison to power boosting gain. The frequency hopping pattern can be random, pseudo-random, or deterministic. The hopping pattern can be cell-specific or UE specific.

### Repetition in the Frequency Domain

Another way of improving the link quality of the PDSCH, and enhancing coverage for U-IoT, is repetition in the frequency domain. In one example, the data on one RB can be extended to multiple RBs by repetition. Repetitions in the frequency domain can reduce the effective coding rate. In one example, an RB can be repeated N times in the adjacent PRBs, where N is an integer greater than or equal to 1. For example, N can be equal to 10 and therefore an RB can be repeated 10 times in the adjacent PRBs.

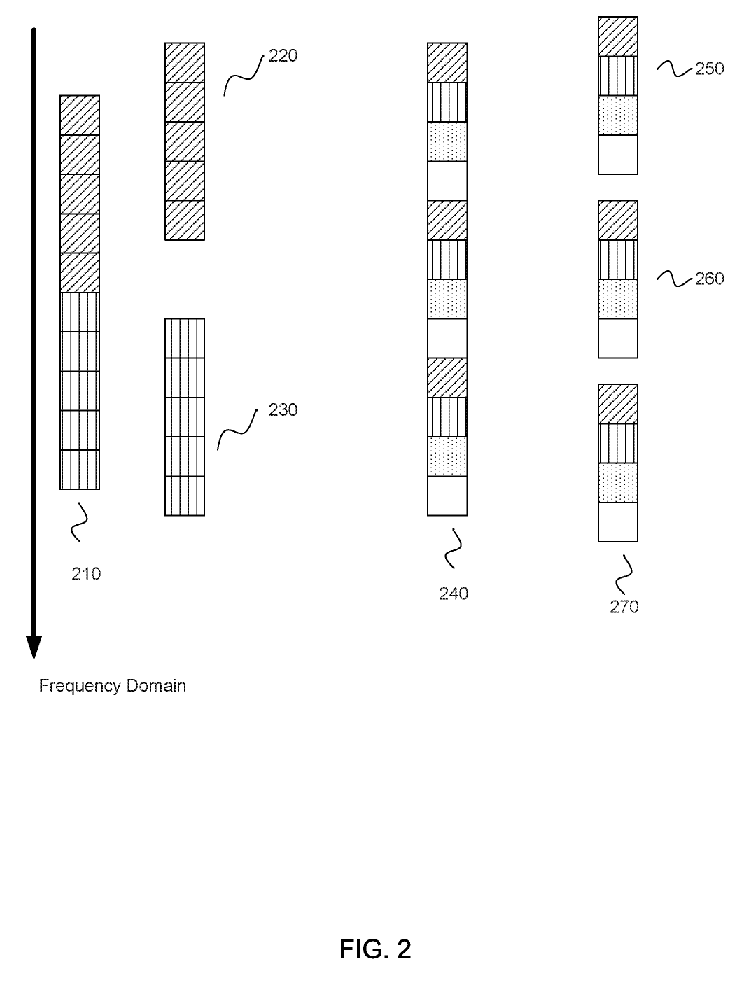

FIG. 2 illustrates an example of repetition in the frequency domain. In 210, an RB is repeated so that there are 5 RBs carrying the same data. RBs with the same markings indicate that the RBs carry the same data. Five of the RBs, as shown in 220, carry data of the same type and the other 5 RBs, as shown in 230 carry data that is different from the data carried in 220. In such an example, one RB has been repeated 5 times and the other RB has been repeated 5 times. In 220, 230, one group of PRBs 220, is non-contiguous with the other group of PRBs 230.

In another example, all of the assigned RBs can be viewed as one set, and can be assigned on other multiple contiguous RBs. For example, multiple RBs that transmit the same data can be assigned in a localized or interleaved way within the whole band. As illustrated in 240, 4 RBs are allocated for data transmission, and these 4 RBs are repeated in the contiguous 12 bands for a repetition number of 3. In 250, 260, 270, as in 240, the 4 RBs are also allocated for data transmission, and these 4 RBs are repeated in the contiguous 12 bands for a repetition number of 3. However, the groups of 4 RBs are not contiguous with other groups of 4 RBs. The group that is repeated can be repeated contiguously, as in 240, or can be repeated non-contiguously, as in 250, 260, 270.

The repetition times illustrated above can be dynamically transmitted by the physical layer, such as DCI, or can be semi-statically transmitted via higher layer signaling, such as RRC signaling. In one example, the repetition times can be indicated by using a two-bit indicator. The bits “00” can represent no repetition. The bits “01” can represent repetition of 2 times; The bits “10” can represent repetition of 4 times; The bits “11” can represent repetition of 8 times.

In another example, a frequency hopping pattern of different repetition entries can be predefined or transmitted by the gNB through physical layer signaling, such as via the DCI, or higher layer signaling, such as RRC signaling. The signaling can be either UE-specific or cell-specific.

In one example, the frequency hopping pattern can be depicted by a fixed offset N_{RB, offset}, wherein there is a value of N_{RB, offset} between two adjacent repetition entries. The RB can be circularly shifted within N_{RB}^{DL}, wherein N_{RB}^{DL} is the number of downlink resource blocks. Circularly shifted means that the shifting can resets to an initial value after reaching a maximum value. For example, the offset can be 1, then 2, then 3, then 4, then 1 again, and so on.

### Repetition in the Time Domain

The link quality of the PDSCH can be increased, and the coverage for U-IoT can be enhanced by repetition in the time domain. In one example, the data to be transmitted on the PDSCH within one subframe can be repeated on multiple subframes. These subframes can be consecutive subframes. The number of repeated subframes, including the original subframe, can be represented by N₁, wherein N₁ is a positive integer value greater than 1. For example, data can be transmitted on the PDSCH on a subframe 1. If N₁ is equal to 5, then the data can be transmitted not only on that subframe 1, but also re-transmitted on subframes 2, 3, 4, and 5. The data can be the same in subframes 1 through 5. The number of repetitions in time, N₁, can be transmitted by the gNB through the physical layer, such as DCI, or higher layer signaling, such as RRC signaling.

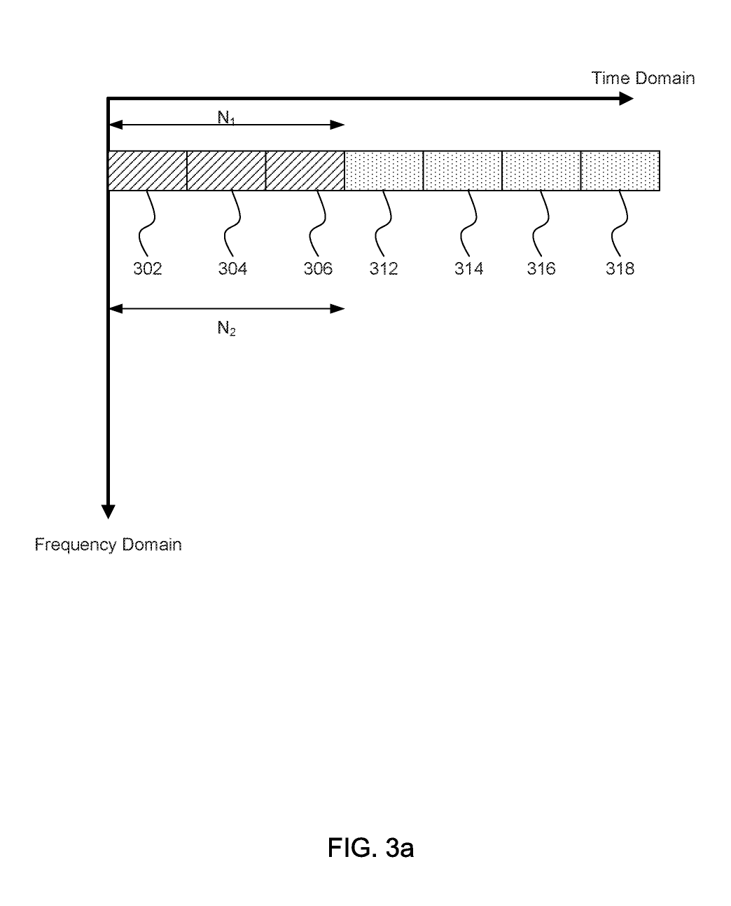

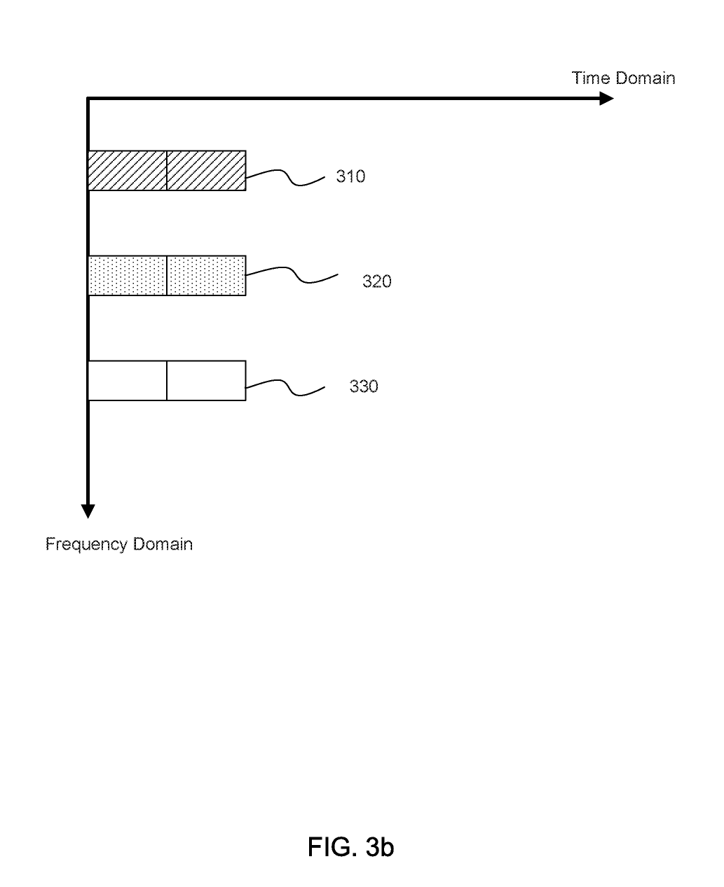

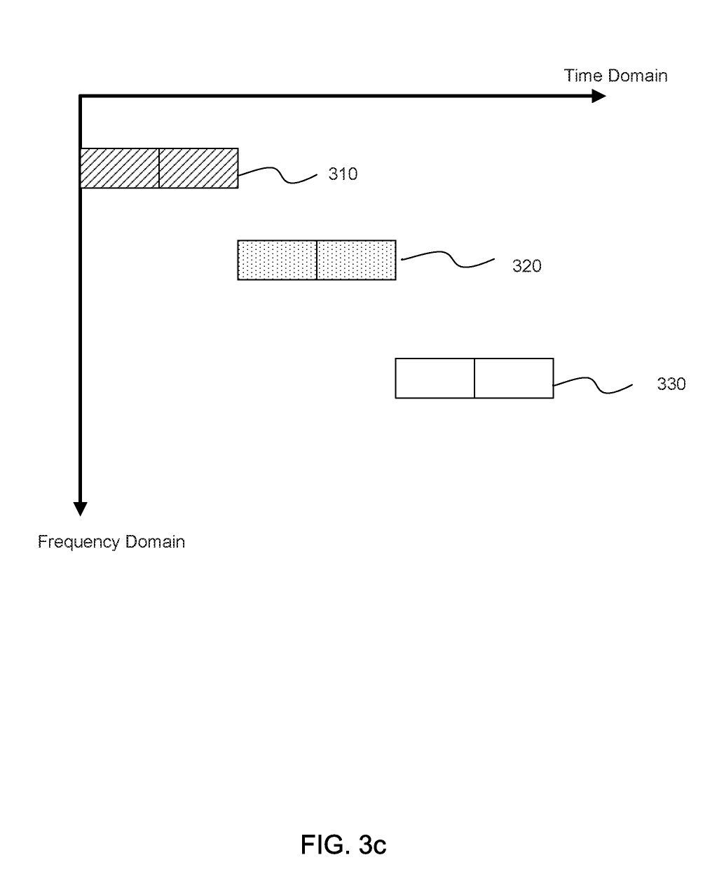

In another example, as illustrated in FIG. 3a, a scrambling sequence for a number of consecutive subframes can be generated, wherein the number of consecutive subframes for the scrambling sequence can be represented by N₂, wherein N₂ is a positive integer value. Different markings illustrated in FIG. 3 indicate that the scrambling sequence has been updated to a different scrambling sequence. The consecutive subframes of 302, 304, 306 use a scrambling sequence for 3 consecutive subframes. In this example, the value of N₂ is 3 because the number of consecutive subframes for the scrambling sequence is 3. In the subframes of 312, 314, 316, and 318, the scrambling sequence has been updated. The value of N₂ for the scrambling sequence is 4 for the subframes of 312, 314, 316, and 318. The number of RBs in a scrambling sequence can be selected based on the desired scrambling sequence. The values of N₁ and N₂ are the same in this example. The number of consecutive subframes for the scrambling sequence, N₂, can be set equal to the value of N₁ to enable quadrature amplitude modulation (QAM) symbol level combination. The scrambling sequence can be updated every N₁ subframes.

In one example, the scrambling sequence can be based on the absolute subframe time, and can use:

$${c}_{init} = {n}_{RNTI} \cdot {2}^{14} + q \cdot {2}^{13} + ⌊ \frac{{n}_{sf}}{{N}_{2}} ⌋ \cdot {2}^{9} + {N}_{ID}^{cell} ,$$

wherein cᵢₙᵢₜ is the initial scrambling sequence, n_{RNTI} is a radio network temporary identifier, q is a codeword index with a value of 0 or 1, n_{sf} is the subframe index for PDSCH transmission, and N_{ID}^{cell} is the cell identifier (ID) with integer values ranging from 0 to 503.

In another example, the length of the N₂ consecutive subframes for QAM symbol level combination can be transmitted via the physical layer, by using DCI, or higher layer signaling, such as RRC signaling. The signaling can be either cell-specific or UE-specific.

In one example, a redundancy version (RV) for the N₂ consecutive subframes with a selected scrambling sequence and a frequency resource can be transmitted. The redundancy version for PDSCH or the N₂ consecutive subframes can be the same. The RV can be transmitted by physical layer signaling, via the DCI, or higher layer signaling, such as RRC signaling. The RV can be increased by 1, and then reset to an initial value per every N₂ subframes. The length of the N₂ consecutive subframes with the same RV can be transmitted via the physical layer, by using DCI, or higher layer signaling, such as RRC signaling. The signaling can be either cell-specific or UE-specific.

In one example, the frequency for N₂ consecutive subframes can be the same on the PDSCH. The frequency can be shifted by NRB,offset RBs for every N₂ subframes. The length of the N₂ consecutive subframes, the N_{RB,Offset}, and the frequency hopping times can be transmitted via the physical layer, by using DCI, or higher layer signaling, such as RRC signaling. The signaling can be either cell-specific or UE-specific.

FIG. 3b and FIG. 3c illustrate examples of repetition in the time domain. The different markings indicate that different data is being transmitted. The subframes in 310 can have different frequency resources from the subframes in 320, which can have different frequency resources from the subframes in 330. The scrambling sequences for 310 can be different from the scrambling sequences of 320, which can be different from the scrambling sequences of 330. As illustrated in FIG. 3b, the subframes in 310 can be in the same time domain as the subframes in 320, which can be in a same time domain as the subframes in 330. As illustrated in FIG. 3c, the subframes in 310 can be in a different time domain from the subframes in 320, which can be in a different time domain from the subframes in 330.

In another example frequency hopping can occur every N₂ subframes. The scrambling can be different for different subframes. The RV can be increased by 1, and then reset to an initial value per every N₂ subframes. Soft bits combining, such as chase combining or incremental redundancy, can also be used in this example.

### MCS Table

The link quality of the PDSCH can be increased, and the coverage for U-IoT can be enhanced by introducing a Modulation and Coding Scheme (MCS) table that is smaller than the legacy MCS table. In one example, a revised MCS table can be reduced in size so that the spectrum efficiency can be reduced to ⅙ of the legacy MCS table.

In another example, additional elements can be added to the legacy MCS table or the revised MCS table. These additional elements can provide lower code rates in comparison to the coding rate currently supported by the legacy MCS table.

### Channel Selection

The link quality of the PDSCH can be increased, and the coverage for U-IoT can be enhanced by channel selection. In one example, the gNB can select a channel with low noise figure so that the signal-to-interference-to-noise ratio (SINR) is higher in the selected channel in comparison with the other channels. Noise figure is a measure of the degradation of the signal-to-noise ratio (SNR). Additionally, the gNB can measure the noise figure of each channel, by measuring the SINR for example, and select a channel in which the noise figure is low compared to the other channels.

In another example, the gNB can choose a channel with a lower carrier frequency among available channels. This can reduce the path-loss and thereby result in a higher SINR in comparison to other channels.

Any of the above ways of increasing the link quality of the PDSCH and enhancing the coverage for U-IoT—power boosting, repetition in the frequency domain, repetition in the time domain, using a revised MCS table and channel selection—can be used in any combination.

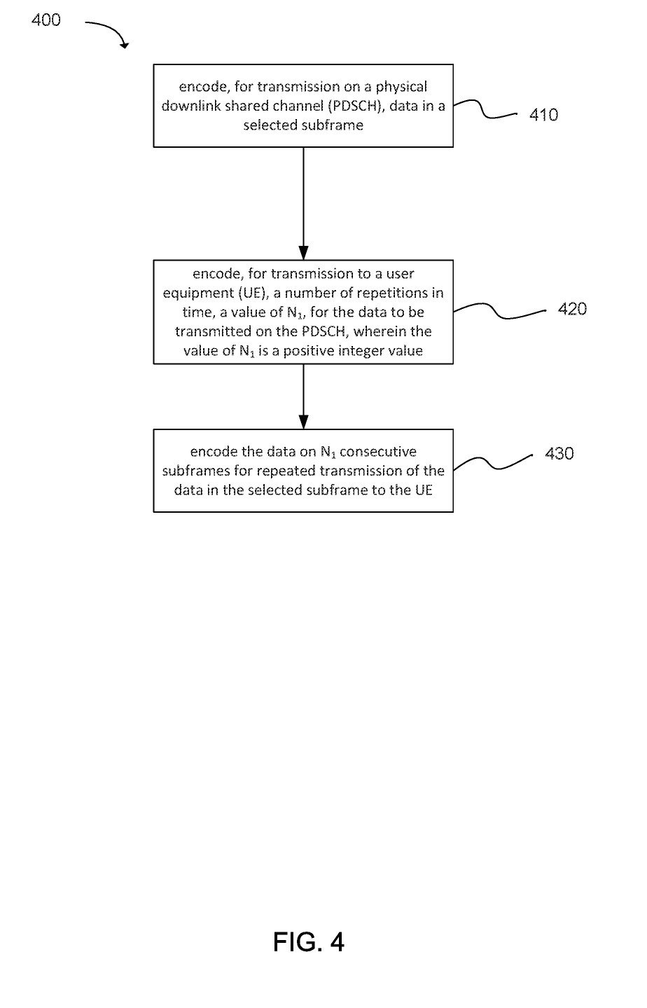

Another example provides functionality 400 of a next generation node B (gNB) operable to provide coverage enhancement for unlicensed internet of things (IoT), as shown in FIG. 4. The gNB can comprise one or more processors. The one or more processors can be configured to encode, for transmission on a physical downlink shared channel (PDSCH), data in a selected subframe, as in block 410. The one or more processors can be configured to encode, for transmission to a user equipment (UE), a number of repetitions in time, a value of N₁, for the data to be transmitted on the PDSCH, wherein the value of N₁ is a positive integer value, as in block 420. The one or more processors can be configured to encode the data on N₁ consecutive subframes for repeated transmission of the data in the selected subframe to the UE, as in block 430. In addition, the gNB can comprise a memory interface configured to receive from a memory the data in the selected subframe.

Another example provides functionality 500 of a user equipment (UE) operable to provide coverage enhancement for unlicensed internet of things (IoT). The UE can comprise one or more processors. The one or more processors can be configured to decode, at the UE, a number of repetitions in time, a value of N₁, for the data to be received on a PDSCH from a next generation node B (gNB), wherein the value of N₁ is a positive integer value, as in block 510. The one or more processors can be configured to decode, at the UE, a repeated transmission received from the gNB, wherein the repeated transmission includes the data on N₁ consecutive subframes, as in block 520. In addition, the UE can comprise a memory interface configured to send to a memory the data received in the repeated transmission.

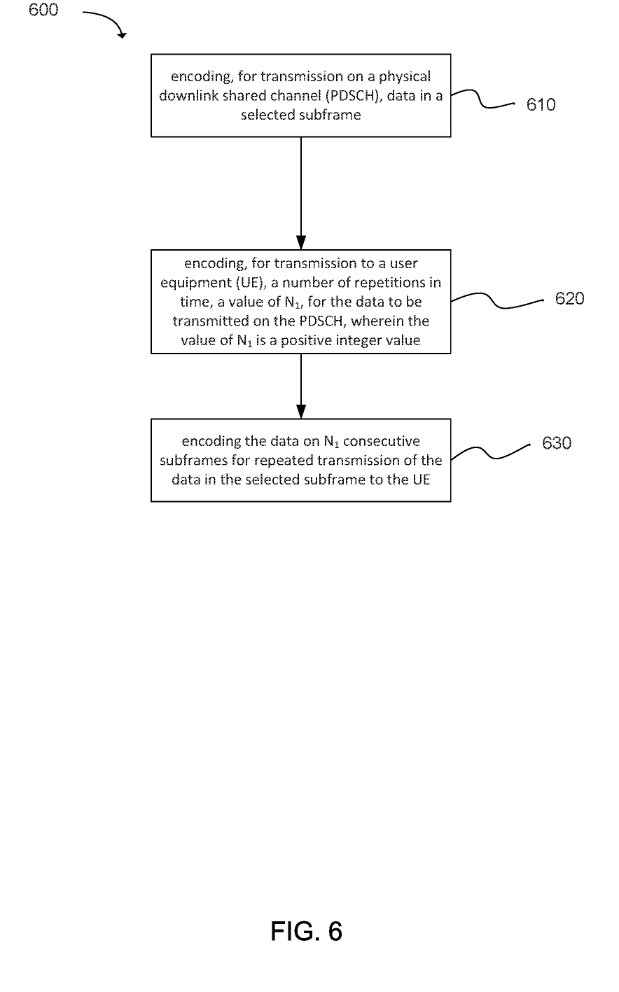

Another example provides at least one machine readable storage medium having instructions 600 embodied thereon for providing coverage enhancement for unlicensed internet of things (IoT), as shown in FIG. 6. The instructions can be executed on a machine, where the instructions are included on at least one computer readable medium or one non-transitory machine readable storage medium. The instructions when executed perform encoding, for transmission on a physical downlink shared channel (PDSCH), data in a selected subframe, as in block 610. The instructions when executed perform: encoding, for transmission to a user equipment (UE), a number of repetitions in time, a value of N₁, for the data to be transmitted on the PDSCH, wherein the value of N₁ is a positive integer value, as in block 620. The instructions when executed perform: encoding the data on N₁ consecutive subframes for repeated transmission of the data in the selected subframe to the UE, as in block 630.

While examples have been provided in which an eNodeB has been specified, they are not intended to be limiting. A fifth generation gNB can be used in place of the eNodeB. Accordingly, unless otherwise stated, any example herein in which an eNodeB has been disclosed, can similarly be disclosed with the use of a gNB (Next Generation node B).

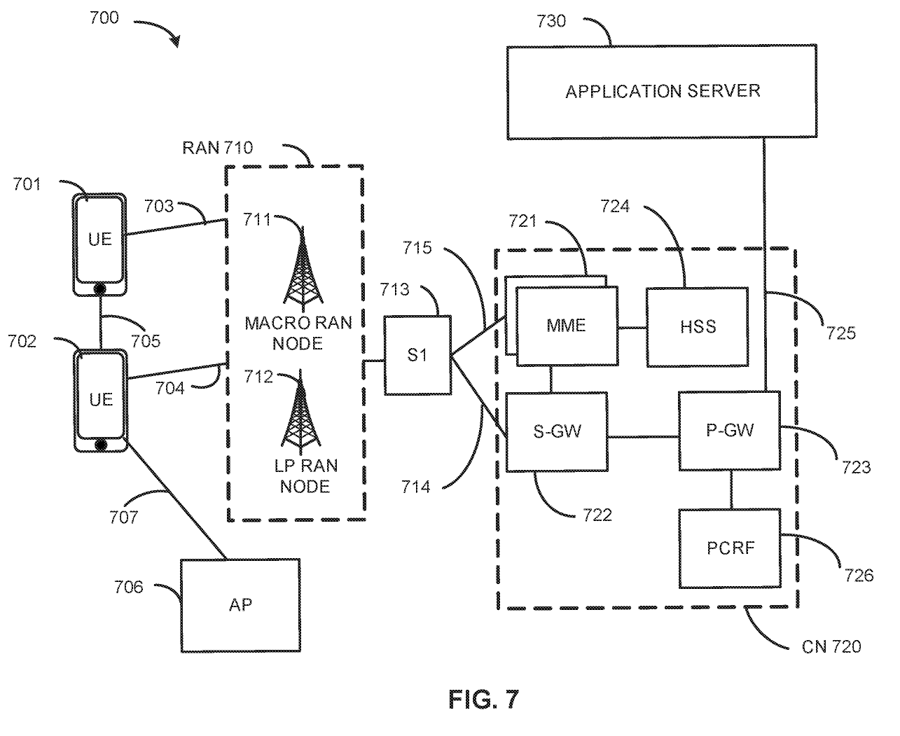

FIG. 7 illustrates an architecture of a system 700 of a network in accordance with some embodiments. The system 700 is shown to include a user equipment (UE) 701 and a UE 702. The UEs 701 and 702 are illustrated as smartphones (e.g., handheld touchscreen mobile computing devices connectable to one or more cellular networks), but may also comprise any mobile or non-mobile computing device, such as Personal Data Assistants (PDAs), pagers, laptop computers, desktop computers, wireless handsets, or any computing device including a wireless communications interface.

In some embodiments, any of the UEs 701 and 702 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 701 and 702 may be configured to connect, e.g., communicatively couple, with a radio access network (RAN) 710—the RAN 710 may be, for example, an Evolved Universal Mobile Telecommunications System (UMTS) Terrestrial Radio Access Network (E-UTRAN), a NextGen RAN (NG RAN), or some other type of RAN. The UEs 701 and 702 utilize connections 703 and 704, respectively, each of which comprises a physical communications interface or layer (discussed in further detail below); in this example, the connections 703 and 704 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 701 and 702 may further directly exchange communication data via a ProSe interface 705. The ProSe interface 705 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 702 is shown to be configured to access an access point (AP) 706 via connection 707. The connection 707 can comprise a local wireless connection, such as a connection consistent with any IEEE 802.15 protocol, wherein the AP 706 would comprise a wireless fidelity (WiFi®) router. In this example, the AP 706 is shown to be connected to the Internet without connecting to the core network of the wireless system (described in further detail below).

The RAN 710 can include one or more access nodes that enable the connections 703 and 704. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The RAN 710 may include one or more RAN nodes for providing macrocells, e.g., macro RAN node 711, and one or more RAN nodes for providing femtocells or picocells (e.g., cells having smaller coverage areas, smaller user capacity, or higher bandwidth compared to macrocells), e.g., low power (LP) RAN node 712.

Any of the RAN nodes 711 and 712 can terminate the air interface protocol and can be the first point of contact for the UEs 701 and 702. In some embodiments, any of the RAN nodes 711 and 712 can fulfill various logical functions for the RAN 710 including, but not limited to, radio network controller (RNC) functions such as radio bearer management, uplink and downlink dynamic radio resource management and data packet scheduling, and mobility management.

In accordance with some embodiments, the UEs 701 and 702 can be configured to communicate using Orthogonal Frequency-Division Multiplexing (OFDM) communication signals with each other or with any of the RAN nodes 711 and 712 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 711 and 712 to the UEs 701 and 702, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink channels that are conveyed using such resource blocks.

The physical downlink shared channel (PDSCH) may carry user data and higher-layer signaling to the UEs 701 and 702. The physical downlink control channel (PDCCH) may carry information about the transport format and resource allocations related to the PDSCH channel, among other things. It may also inform the UEs 701 and 702 about the transport format, resource allocation, and H-ARQ (Hybrid Automatic Repeat Request) information related to the uplink shared channel. Typically, downlink scheduling (assigning control and shared channel resource blocks to the UE 702 within a cell) may be performed at any of the RAN nodes 711 and 712 based on channel quality information fed back from any of the UEs 701 and 702. The downlink resource assignment information may be sent on the PDCCH used for (e.g., assigned to) each of the UEs 701 and 702.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as an enhanced resource element groups (EREGs). An ECCE may have other numbers of EREGs in some situations.

The RAN 710 is shown to be communicatively coupled to a core network (CN) 720—via an S1 interface 713. In embodiments, the CN 720 may be an evolved packet core (EPC) network, a NextGen Packet Core (NPC) network, or some other type of CN. In this embodiment the S1 interface 713 is split into two parts: the S1-U interface 714, which carries traffic data between the RAN nodes 711 and 712 and the serving gateway (S-GW) 722, and the S1-mobility management entity (MME) interface 715, which is a signaling interface between the RAN nodes 711 and 712 and MMEs 721.

In this embodiment, the CN 720 comprises the MMEs 721, the S-GW 722, the Packet Data Network (PDN) Gateway (P-GW) 723, and a home subscriber server (HSS) 724. The MMEs 721 may be similar in function to the control plane of legacy Serving General Packet Radio Service (GPRS) Support Nodes (SGSN). The MMEs 721 may manage mobility aspects in access such as gateway selection and tracking area list management. The HSS 724 may comprise a database for network users, including subscription-related information to support the network entities' handling of communication sessions. The CN 720 may comprise one or several HSSs 724, depending on the number of mobile subscribers, on the capacity of the equipment, on the organization of the network, etc. For example, the HSS 724 can provide support for routing/roaming, authentication, authorization, naming/addressing resolution, location dependencies, etc.

The S-GW 722 may terminate the S1 interface 713 towards the RAN 710, and routes data packets between the RAN 710 and the CN 720. In addition, the S-GW 722 may be a local mobility anchor point for inter-RAN node handovers and also may provide an anchor for inter-3GPP mobility. Other responsibilities may include lawful intercept, charging, and some policy enforcement.

The P-GW 723 may terminate an SGi interface toward a PDN. The P-GW 723 may route data packets between the EPC network 723 and external networks such as a network including the application server 730 (alternatively referred to as application function (AF)) via an Internet Protocol (IP) interface 725. Generally, the application server 730 may be an element offering applications that use IP bearer resources with the core network (e.g., UMTS Packet Services (PS) domain, LTE PS data services, etc.). In this embodiment, the P-GW 723 is shown to be communicatively coupled to an application server 730 via an IP communications interface 725. The application server 730 can also be configured to support one or more communication services (e.g., Voice-over-Internet Protocol (VoIP) sessions, PTT sessions, group communication sessions, social networking services, etc.) for the UEs 701 and 702 via the CN 720.

The P-GW 723 may further be a node for policy enforcement and charging data collection. Policy and Charging Enforcement Function (PCRF) 726 is the policy and charging control element of the CN 720. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 726 may be communicatively coupled to the application server 730 via the P-GW 723. The application server 730 may signal the PCRF 726 to indicate a new service flow and select the appropriate Quality of Service (QoS) and charging parameters. The PCRF 726 may provision this rule into a Policy and Charging Enforcement Function (PCEF) (not shown) with the appropriate traffic flow template (TFT) and QoS class of identifier (QCI), which commences the QoS and charging as specified by the application server 730.

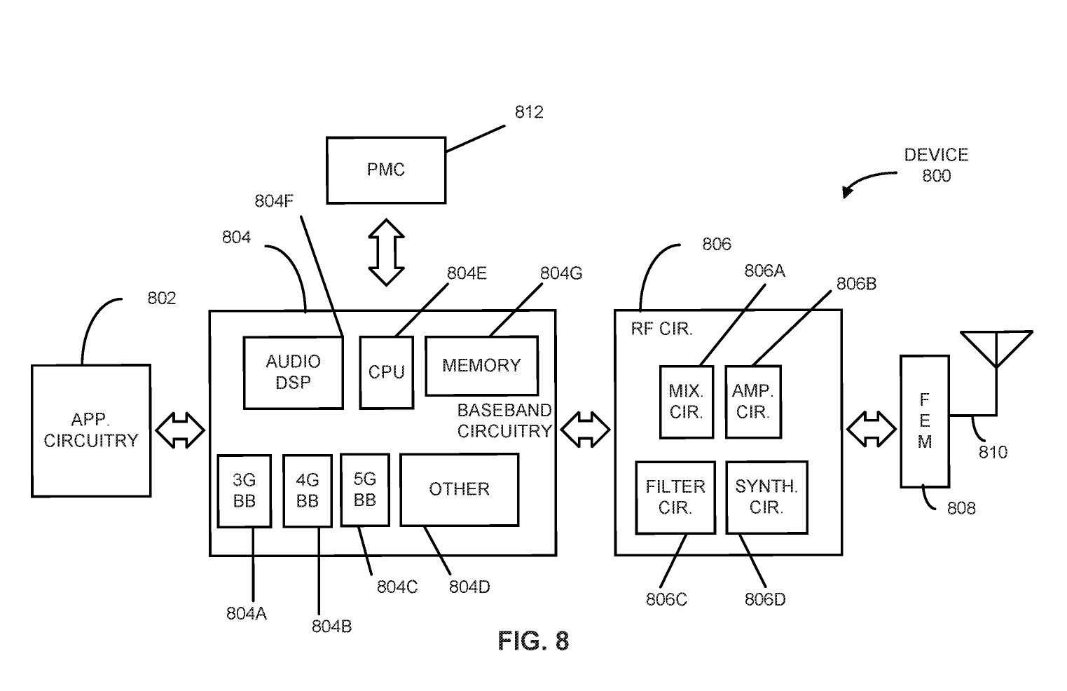

FIG. 8 illustrates example components of a device 800 in accordance with some embodiments. In some embodiments, the device 800 may include application circuitry 802, baseband circuitry 804, Radio Frequency (RF) circuitry 806, front-end module (FEM) circuitry 808, one or more antennas 810, and power management circuitry (PMC) 812 coupled together at least as shown. The components of the illustrated device 800 may be included in a UE or a RAN node. In some embodiments, the device 800 may include less elements (e.g., a RAN node may not utilize application circuitry 802, and instead include a processor/controller to process IP data received from an EPC). In some embodiments, the device 800 may include additional elements such as, for example, memory/storage, display, camera, sensor, or input/output (I/O) interface. In other embodiments, the components described below may be included in more than one device (e.g., said circuitries may be separately included in more than one device for Cloud-RAN (C-RAN) implementations).

The application circuitry 802 may include one or more application processors. For example, the application circuitry 802 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 800. In some embodiments, processors of application circuitry 802 may process IP data packets received from an EPC.

The baseband circuitry 804 may include circuitry such as, but not limited to, one or more single-core or multi-core processors. The baseband circuitry 804 may include one or more baseband processors or control logic to process baseband signals received from a receive signal path of the RF circuitry 806 and to generate baseband signals for a transmit signal path of the RF circuitry 806. Baseband processing circuitry 804 may interface with the application circuitry 802 for generation and processing of the baseband signals and for controlling operations of the RF circuitry 806. For example, in some embodiments, the baseband circuitry 804 may include a third generation (3G) baseband processor 804a, a fourth generation (4G) baseband processor 804b, a fifth generation (5G) baseband processor 804c, or other baseband processor(s) 804d for other existing generations, generations in development or to be developed in the future (e.g., second generation (2G), sixth generation (6G), etc.). The baseband circuitry 804 (e.g., one or more of baseband processors 804a-d) may handle various radio control functions that enable communication with one or more radio networks via the RF circuitry 806. In other embodiments, some or all of the functionality of baseband processors 804a-d may be included in modules stored in the memory 804g and executed via a Central Processing Unit (CPU) 804e. The radio control functions may include, but are not limited to, signal modulation/demodulation, encoding/decoding, radio frequency shifting, etc. In some embodiments, modulation/demodulation circuitry of the baseband circuitry 804 may include Fast-Fourier Transform (FFT), precoding, or constellation mapping/demapping functionality. In some embodiments, encoding/decoding circuitry of the baseband circuitry 804 may include convolution, tail-biting convolution, turbo, Viterbi, or Low Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 804 may include one or more audio digital signal processor(s) (DSP) 804f. The audio DSP(s) 804f may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 804 and the application circuitry 802 may be implemented together such as, for example, on a system on a chip (SOC).

In some embodiments, the baseband circuitry 804 may provide for communication compatible with one or more radio technologies. For example, in some embodiments, the baseband circuitry 804 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 804 is configured to support radio communications of more than one wireless protocol may be referred to as multi-mode baseband circuitry.

RF circuitry 806 may enable communication with wireless networks using modulated electromagnetic radiation through a non-solid medium. In various embodiments, the RF circuitry 806 may include switches, filters, amplifiers, etc. to facilitate the communication with the wireless network. RF circuitry 806 may include a receive signal path which may include circuitry to down-convert RF signals received from the FEM circuitry 808 and provide baseband signals to the baseband circuitry 804. RF circuitry 806 may also include a transmit signal path which may include circuitry to up-convert baseband signals provided by the baseband circuitry 804 and provide RF output signals to the FEM circuitry 808 for transmission.

In some embodiments, the receive signal path of the RF circuitry 806 may include mixer circuitry 806a, amplifier circuitry 806b and filter circuitry 806c. In some embodiments, the transmit signal path of the RF circuitry 806 may include filter circuitry 806c and mixer circuitry 806a. RF circuitry 806 may also include synthesizer circuitry 806d for synthesizing a frequency for use by the mixer circuitry 806a of the receive signal path and the transmit signal path. In some embodiments, the mixer circuitry 806a of the receive signal path may be configured to down-convert RF signals received from the FEM circuitry 808 based on the synthesized frequency provided by synthesizer circuitry 806d. The amplifier circuitry 806b may be configured to amplify the down-converted signals and the filter circuitry 806c may be a low-pass filter (LPF) or band-pass filter (BPF) configured to remove unwanted signals from the down-converted signals to generate output baseband signals. Output baseband signals may be provided to the baseband circuitry 804 for further processing. In some embodiments, the output baseband signals may be zero-frequency baseband signals, although this is not a necessity. In some embodiments, mixer circuitry 806a of the receive signal path may comprise passive mixers, although the scope of the embodiments is not limited in this respect.

In some embodiments, the mixer circuitry 806a of the transmit signal path may be configured to up-convert input baseband signals based on the synthesized frequency provided by the synthesizer circuitry 806d to generate RF output signals for the FEM circuitry 808. The baseband signals may be provided by the baseband circuitry 804 and may be filtered by filter circuitry 806c.

In some embodiments, the mixer circuitry 806a of the receive signal path and the mixer circuitry 806a of the transmit signal path may include two or more mixers and may be arranged for quadrature downconversion and upconversion, respectively. In some embodiments, the mixer circuitry 806a of the receive signal path and the mixer circuitry 806a of the transmit signal path may include two or more mixers and may be arranged for image rejection (e.g., Hartley image rejection). In some embodiments, the mixer circuitry 806a of the receive signal path and the mixer circuitry 806a may be arranged for direct downconversion and direct upconversion, respectively. In some embodiments, the mixer circuitry 806a of the receive signal path and the mixer circuitry 806a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 806 may include analog-to-digital converter (ADC) and digital-to-analog converter (DAC) circuitry and the baseband circuitry 804 may include a digital baseband interface to communicate with the RF circuitry 806.

In some dual-mode embodiments, a separate radio IC circuitry may be provided for processing signals for each spectrum, although the scope of the embodiments is not limited in this respect.

In some embodiments, the synthesizer circuitry 806d may be a fractional-N synthesizer or a fractional N/N+1 synthesizer, although the scope of the embodiments is not limited in this respect as other types of frequency synthesizers may be suitable. For example, synthesizer circuitry 806d may be a delta-sigma synthesizer, a frequency multiplier, or a synthesizer comprising a phase-locked loop with a frequency divider.

The synthesizer circuitry 806d may be configured to synthesize an output frequency for use by the mixer circuitry 806a of the RF circuitry 806 based on a frequency input and a divider control input. In some embodiments, the synthesizer circuitry 806d may be a fractional N/N+1 synthesizer.

In some embodiments, frequency input may be provided by a voltage controlled oscillator (VCO), although that is not a necessity. Divider control input may be provided by either the baseband circuitry 804 or the applications processor 802 depending on the desired output frequency. In some embodiments, a divider control input (e.g., N) may be determined from a look-up table based on a channel indicated by the applications processor 802.

Synthesizer circuitry 806d of the RF circuitry 806 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 806d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (fLO). In some embodiments, the RF circuitry 806 may include an IQ/polar converter.

FEM circuitry 808 may include a receive signal path which may include circuitry configured to operate on RF signals received from one or more antennas 810, amplify the received signals and provide the amplified versions of the received signals to the RF circuitry 806 for further processing. FEM circuitry 808 may also include a transmit signal path which may include circuitry configured to amplify signals for transmission provided by the RF circuitry 806 for transmission by one or more of the one or more antennas 810. In various embodiments, the amplification through the transmit or receive signal paths may be done solely in the RF circuitry 806, solely in the FEM 808, or in both the RF circuitry 806 and the FEM 808.

In some embodiments, the FEM circuitry 808 may include a TX/RX switch to switch between transmit mode and receive mode operation. The FEM circuitry may include a receive signal path and a transmit signal path. The receive signal path of the FEM circuitry may include an LNA to amplify received RF signals and provide the amplified received RF signals as an output (e.g., to the RF circuitry 806). The transmit signal path of the FEM circuitry 808 may include a power amplifier (PA) to amplify input RF signals (e.g., provided by RF circuitry 806), and one or more filters to generate RF signals for subsequent transmission (e.g., by one or more of the one or more antennas 810).

In some embodiments, the PMC 812 may manage power provided to the baseband circuitry 804. In particular, the PMC 812 may control power-source selection, voltage scaling, battery charging, or DC-to-DC conversion. The PMC 812 may often be included when the device 800 is capable of being powered by a battery, for example, when the device is included in a UE. The PMC 812 may increase the power conversion efficiency while providing desirable implementation size and heat dissipation characteristics.

While FIG. 8 shows the PMC 812 coupled only with the baseband circuitry 804. However, in other embodiments, the PMC 812 may be additionally or alternatively coupled with, and perform similar power management operations for, other components such as, but not limited to, application circuitry 802, RF circuitry 806, or FEM 808.

In some embodiments, the PMC 812 may control, or otherwise be part of, various power saving mechanisms of the device 800. For example, if the device 800 is in an RRC_Connected state, where it is still connected to the RAN node as it expects to receive traffic shortly, then it may enter a state known as Discontinuous Reception Mode (DRX) after a period of inactivity. During this state, the device 800 may power down for brief intervals of time and thus save power.

If there is no data traffic activity for an extended period of time, then the device 800 may transition off to an RRC_Idle state, where it disconnects from the network and does not perform operations such as channel quality feedback, handover, etc. The device 800 goes into a very low power state and it performs paging where again it periodically wakes up to listen to the network and then powers down again. The device 800 may not receive data in this state, in order to receive data, it can transition back to RRC_Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

Processors of the application circuitry 802 and processors of the baseband circuitry 804 may be used to execute elements of one or more instances of a protocol stack. For example, processors of the baseband circuitry 804, alone or in combination, may be used execute Layer 3, Layer 2, or Layer 1 functionality, while processors of the application circuitry 804 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

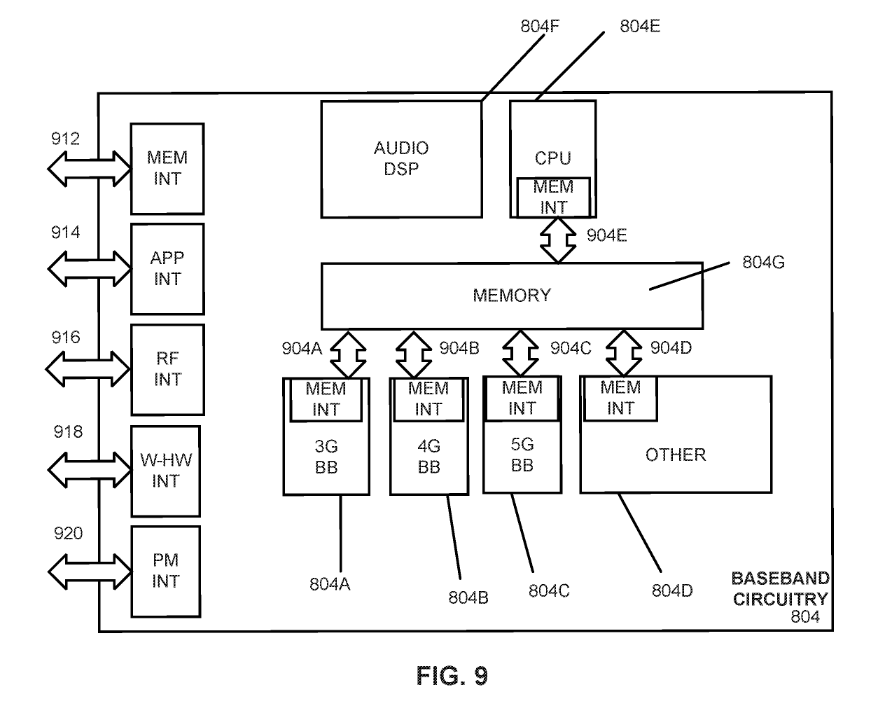

FIG. 9 illustrates example interfaces of baseband circuitry in accordance with some embodiments. As discussed above, the baseband circuitry 804 of FIG. 8 may comprise processors 804a-804e and a memory 804g utilized by said processors. Each of the processors 804a-804e may include a memory interface, 904a-904e, respectively, to send/receive data to/from the memory 804g.

The baseband circuitry 804 may further include one or more interfaces to communicatively couple to other circuitries/devices, such as a memory interface 912 (e.g., an interface to send/receive data to/from memory external to the baseband circuitry 804), an application circuitry interface 914 (e.g., an interface to send/receive data to/from the application circuitry 802 of FIG. 8), an RF circuitry interface 916 (e.g., an interface to send/receive data to/from RF circuitry 806 of FIG. 8), a wireless hardware connectivity interface 918 (e.g., an interface to send/receive data to/from Near Field Communication (NFC) components, Bluetooth® components (e.g., Bluetooth® Low Energy), Wi-Fi® components, and other communication components), and a power management interface 920 (e.g., an interface to send/receive power or control signals to/from the PMC 812.

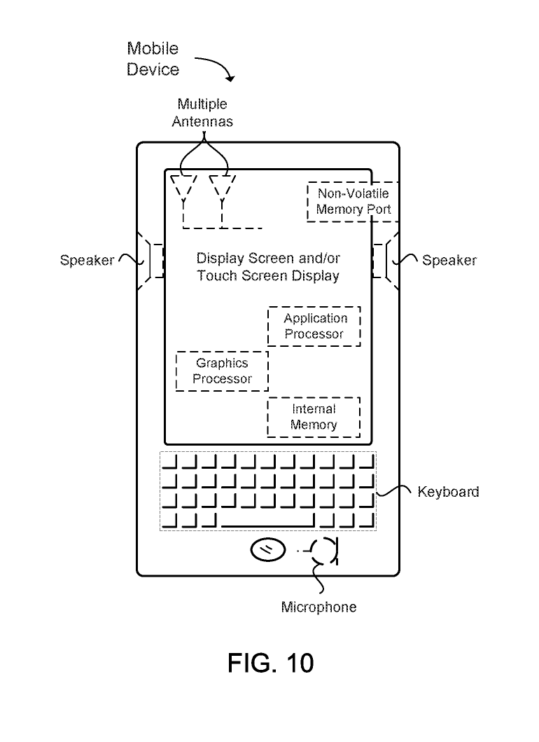

FIG. 10 provides an example illustration of the wireless device, such as a user equipment (UE), a mobile station (MS), a mobile wireless device, a mobile communication device, a tablet, a handset, or other type of wireless device. The wireless device can include one or more antennas configured to communicate with a node, macro node, low power node (LPN), or, transmission station, such as a base station (BS), an evolved Node B (eNB), a baseband processing unit (BBU), a remote radio head (RRH), a remote radio equipment (RRE), a relay station (RS), a radio equipment (RE), or other type of wireless wide area network (WWAN) access point. The wireless device can be configured to communicate using at least one wireless communication standard such as, but not limited to, 3GPP LTE, WiMAX, High Speed Packet Access (HSPA), Bluetooth, and WiFi. The wireless device can communicate using separate antennas for each wireless communication standard or shared antennas for multiple wireless communication standards. The wireless device can communicate in a wireless local area network (WLAN), a wireless personal area network (WPAN), and/or a WWAN. The wireless device can also comprise a wireless modem. The wireless modem can comprise, for example, a wireless radio transceiver and baseband circuitry (e.g., a baseband processor). The wireless modem can, in one example, modulate signals that the wireless device transmits via the one or more antennas and demodulate signals that the wireless device receives via the one or more antennas.

FIG. 10 also provides an illustration of a microphone and one or more speakers that can be used for audio input and output from the wireless device. The display screen can be a liquid crystal display (LCD) screen, or other type of display screen such as an organic light emitting diode (OLED) display. The display screen can be configured as a touch screen. The touch screen can use capacitive, resistive, or another type of touch screen technology. An application processor and a graphics processor can be coupled to internal memory to provide processing and display capabilities. A non-volatile memory port can also be used to provide data input/output options to a user. The non-volatile memory port can also be used to expand the memory capabilities of the wireless device. A keyboard can be integrated with the wireless device or wirelessly connected to the wireless device to provide additional user input. A virtual keyboard can also be provided using the touch screen.

### EXAMPLES

The following examples pertain to specific technology embodiments and point out specific features, elements, or actions that can be used or otherwise combined in achieving such embodiments.

Example 1 includes an apparatus of a next generation node B (gNB) operable to provide coverage enhancement for unlicensed internet of things (IoT), comprising: one or more processors configured to: encode, for transmission on a physical downlink shared channel (PDSCH), data in a selected subframe; encode, for transmission to a user equipment (UE), a number of repetitions in time, a value of N₁, for the data to be transmitted on the PDSCH, wherein the value of N₁ is a positive integer value; and encode the data on N₁ consecutive subframes for repeated transmission of the data in the selected subframe to the UE; and a memory interface configured to receive from a memory the data in the selected subframe.

Example 2 includes the apparatus of Example 1, wherein the one or more processors are further configured to: generate a scrambling sequence for N₂ consecutive subframes; and set a value of N₂ equal to the value of N₁ to enable quadrature amplitude modulation (QAM) symbol level combination.

Example 3 includes the apparatus of Example 2, wherein the one or more processors are further configured to: generate the scrambling sequence using:

$${c}_{init} = {n}_{RNTI} \cdot {2}^{14} + q \cdot {2}^{13} + ⌊ \frac{{n}_{sf}}{{N}_{2}} ⌋ \cdot {2}^{9} + {N}_{ID}^{cell}$$

wherein: cᵢₙᵢₜ is an initial scrambling sequence, n_{RNTI} is a radio network temporary identifier, N_{ID}^{cell} is a cell identifier (ID), n_{sf} is a subframe index, and q is a codeword index.

Example 4 includes the apparatus of Example 2, wherein the one or more processors are further configured to: generate an updated scrambling sequence for every N₂ subframes.

Example 5 includes the apparatus of Example 2, wherein the one or more processors are further configured to: encode, for transmission to the UE, a length of the N₂ consecutive subframes for QAM symbol level combination using a downlink control information (DCI) signaling or higher layer signaling.

Example 6 includes the apparatus of Example 5, wherein the DCI signaling or the higher layer signaling is either UE-specific or cell-specific.

Example 7 includes the apparatus of Example 2, wherein the one or more processors are further configured to: encode, for transmission to the UE, a redundancy version (RV) for the N₂ consecutive subframes with a selected scrambling sequence and a frequency resource.

Example 8 includes an apparatus of a user equipment (UE) operable to provide coverage enhancement for unlicensed internet of things (IoT), the apparatus comprising: one or more processors configured to: decode, at the UE, a number of repetitions in time, a value of N₁, for the data to be received on a PDSCH from a next generation node B (gNB), wherein the value of N₁ is a positive integer value; and decode, at the UE, a repeated transmission received from the gNB, wherein the repeated transmission includes the data on N₁ consecutive subframes; and a memory interface configured to send to a memory the data received in the repeated transmission.

Example 9 includes the apparatus of Example 8, wherein the one or more processors are further configured to: identify a scrambling sequence for N₂ consecutive subframes; and set a value of N₂ equal to the value of N₁ to enable decoding of a quadrature amplitude modulation (QAM) symbol level combination.

Example 10 includes the apparatus of Example 9, wherein the one or more processors are further configured to: identify the scrambling sequence using:

$${c}_{init} = {n}_{RNTI} \cdot {2}^{14} + q \cdot {2}^{13} + ⌊ \frac{{n}_{sf}}{{N}_{2}} ⌋ \cdot {2}^{9} + {N}_{ID}^{cell}$$

wherein: cᵢₙᵢₜ is an initial scrambling sequence, n_{RNTI} is a radio network temporary identifier, N_{ID}^{cell} is a cell identifier (ID), n_{sf} is a subframe index, and q is a codeword index.

Example 11 includes the apparatus of Example 9, wherein the one or more processors are further configured to: identify an updated scrambling sequence for every N₂ subframes.

Example 12 includes the apparatus of Example 9, wherein the one or more processors are further configured to: decode, at the UE, a length of the N₂ consecutive subframes for decoding of the QAM symbol level combination, wherein the length is received via downlink control information (DCI) signaling or higher layer signaling.

Example 13 includes the apparatus of Example 12, wherein the DCI signaling or the higher layer signaling is either UE-specific or cell-specific.

Example 14 includes the apparatus of Example 9, wherein the one or more processors are further configured to: decode, at the UE, a redundancy version (RV) for the N₂ consecutive subframes with a selected scrambling sequence and a frequency resource.

Example 15 includes at least one machine readable storage medium having instructions embodied thereon for providing coverage enhancement for unlicensed internet of things (IoT), the instructions when executed by one or more processors at a next generation node B (gNB) perform the following: encoding, for transmission on a physical downlink shared channel (PDSCH), data in a selected subframe; encoding, for transmission to a user equipment (UE), a number of repetitions in time, a value of N₁, for the data to be transmitted on the PDSCH, wherein the value of N₁ is a positive integer value; and encoding the data on N₁ consecutive subframes for repeated transmission of the data in the selected subframe to the UE.

Example 16 includes the at least one machine readable storage medium of Example 15, wherein the instructions further perform: generating a scrambling sequence for N₂ consecutive subframes; and setting a value of N₂ equal to the value of N₁ to enable quadrature amplitude modulation (QAM) symbol level combination.

Example 17 includes the at least one machine readable storage medium of Example 16, wherein the instructions further perform: generating the scrambling sequence using:

$${c}_{init} = {n}_{RNTI} \cdot {2}^{14} + q \cdot {2}^{13} + ⌊ \frac{{n}_{sf}}{{N}_{2}} ⌋ \cdot {2}^{9} + {N}_{ID}^{cell}$$

wherein: cᵢₙᵢₜ is an initial scrambling sequence, n_{RNTI} is a radio network temporary identifier, N_{ID}^{cell} is a cell identifier (ID), n_{sf} is a subframe index, and q is a codeword index.

Example 18 includes the at least one machine readable storage medium of Example 16, wherein the instructions further perform: generating an updated scrambling sequence for every N₂ subframes.

Example 19 includes the at least one machine readable storage medium of Example 16, wherein the instructions further perform: encoding, for transmission to a UE, a length of the N₂ consecutive subframes for QAM symbol level combination using a downlink control information (DCI) signaling or higher layer signaling.

Example 20 includes the at least one machine readable storage medium of Example 19, wherein the DCI signaling or the higher layer signaling is either UE-specific or cell-specific.

Example 21 includes a next generation node B (gNB) operable to provide coverage enhancement for unlicensed internet of things (IoT), the gNB comprising: means for encoding, for transmission on a physical downlink shared channel (PDSCH), data in a selected subframe; means for encoding, for transmission to a user equipment (UE), a number of repetitions in time, a value of N₁, for the data to be transmitted on the PDSCH, wherein the value of N₁ is a positive integer value; and means for encoding the data on N₁ consecutive subframes for repeated transmission of the data in the selected subframe to the UE.

Example 22 includes the gNB of Example 21, the gNB further comprising: means for generating a scrambling sequence for N₂ consecutive subframes; and means for setting a value of N₂ equal to the value of N₁ to enable quadrature amplitude modulation (QAM) symbol level combination.

Example 23 includes the gNB of Example 22, the gNB further comprising: means for generating the scrambling sequence using:

$${c}_{init} = {n}_{RNTI} \cdot {2}^{14} + q \cdot {2}^{13} + ⌊ \frac{{n}_{sf}}{{N}_{2}} ⌋ \cdot {2}^{9} + {N}_{ID}^{cell}$$

wherein: cᵢₙᵢₜ is an initial scrambling sequence, n_{RNTI} is a radio network temporary identifier, N_{ID}^{cell} is a cell identifier (ID), n_{sf} is a subframe index, and q is a codeword index.

Example 24 includes the gNB of Example 22, the gNB further comprising: means for generating an updated scrambling sequence for every N₂ subframes.

Example 25 includes the gNB of Example 22, the gNB further comprising: means for encoding, for transmission to a UE, a length of the N₂ consecutive subframes for QAM symbol level combination using a downlink control information (DCI) signaling or higher layer signaling.

Example 26 includes the gNB of Example 25, wherein the DCI signaling or the higher layer signaling is either UE-specific or cell-specific.

Example 27 includes an apparatus of a next generation node B (gNB) operable to provide coverage enhancement for unlicensed internet of things (IoT), comprising: one or more processors configured to: encode, for transmission on a physical downlink shared channel (PDSCH), data in a selected subframe; encode, for transmission to a user equipment (UE), a number of repetitions in time, a value of N₁, for the data to be transmitted on the PDSCH, wherein the value of N₁ is a positive integer value; and encode the data on N₁ consecutive subframes for repeated transmission of the data in the selected subframe to the UE; and a memory interface configured to receive from a memory the data in the selected subframe.

Example 28 includes the apparatus of Example 27, wherein the one or more processors are further configured to: generate a scrambling sequence for N₂ consecutive subframes; and set a value of N₂ equal to the value of N₁ to enable quadrature amplitude modulation (QAM) symbol level combination.

Example 29 includes the apparatus of Example 28, wherein the one or more processors are further configured to: generate the scrambling sequence using:

$${c}_{init} = {n}_{RNTI} \cdot {2}^{14} + q \cdot {2}^{13} + ⌊ \frac{{n}_{sf}}{{N}_{2}} ⌋ \cdot {2}^{9} + {N}_{ID}^{cell}$$

wherein: cᵢₙᵢₜ is the initial scrambling sequence, n_{RNTI} is a radio network temporary identifier, N_{ID}^{cell} is a cell identifier (ID), n_{sf} is a subframe index, and q is a codeword index; or generate an updated scrambling sequence for every N₂ subframes; or encode, for transmission to the UE, a redundancy version (RV) for the N₂ consecutive subframes with a selected scrambling sequence and a frequency resource.

Example 30 includes the apparatus of Example 28, wherein the one or more processors are further configured to: encode, for transmission to the UE, a length of the N₂ consecutive subframes for QAM symbol level combination using a downlink control information (DCI) signaling or higher layer signaling.

Example 31 includes the apparatus of Example 30, wherein the DCI signaling or the higher layer signaling is either UE-specific or cell-specific.

Example 32 includes an apparatus of a user equipment (UE) operable to provide coverage enhancement for unlicensed internet of things (IoT), the apparatus comprising: one or more processors configured to: decode, at the UE, a number of repetitions in time, a value of N₁, for the data to be received on a PDSCH from a next generation node B (gNB), wherein the value of N₁ is a positive integer value; and decode, at the UE, a repeated transmission received from the gNB, wherein the repeated transmission includes the data on N₁ consecutive subframes; and a memory interface configured to send to a memory the data received in the repeated transmission.

Example 33 includes the apparatus of Example 32, wherein the one or more processors are further configured to: identify a scrambling sequence for N₂ consecutive subframes; and set a value of N₂ equal to the value of N₁ to enable decoding of a quadrature amplitude modulation (QAM) symbol level combination.

Example 34 includes the apparatus of Example 33, wherein the one or more processors are further configured to: identify the scrambling sequence using:

$${c}_{init} = {n}_{RNTI} \cdot {2}^{14} + q \cdot {2}^{13} + ⌊ \frac{{n}_{sf}}{{N}_{2}} ⌋ \cdot {2}^{9} + {N}_{ID}^{cell}$$

wherein: cᵢₙᵢₜ is an initial scrambling sequence, n_{RNTI} is a radio network temporary identifier, N_{ID}^{cell} is a cell identifier (ID), n_{sf} is a subframe index, and q is a codeword index; or identify an updated scrambling sequence for every N₂ subframes; or decode, at the UE, a redundancy version (RV) for the N₂ consecutive subframes with a selected scrambling sequence and a frequency resource.

Example 35 includes the apparatus of Example 33, wherein the one or more processors are further configured to: decode, at the UE, a length of the N₂ consecutive subframes for decoding of the QAM symbol level combination, wherein the length is received via downlink control information (DCI) signaling or higher layer signaling.

Example 36 includes the apparatus of Example 35, wherein the DCI signaling or the higher layer signaling is either UE-specific or cell-specific.

Example 37 includes at least one machine readable storage medium having instructions embodied thereon for providing coverage enhancement for unlicensed internet of things (IoT), the instructions when executed by one or more processors at a next generation node B (gNB) perform the following: encoding, for transmission on a physical downlink shared channel (PDSCH), data in a selected subframe; encoding, for transmission to a user equipment (UE), a number of repetitions in time, a value of N₁, for the data to be transmitted on the PDSCH, wherein the value of N₁ is a positive integer value; and encoding the data on N₁ consecutive subframes for repeated transmission of the data in the selected subframe to the UE.

Example 38 includes the at least one machine readable storage medium of Example 37, wherein the instructions further perform: generating a scrambling sequence for N₂ consecutive subframes; and setting a value of N₂ equal to the value of N₁ to enable quadrature amplitude modulation (QAM) symbol level combination.

Example 39 includes the at least one machine readable storage medium of Example 38, wherein the instructions further perform: generating the scrambling sequence using:

$${c}_{init} = {n}_{RNTI} \cdot {2}^{14} + q \cdot {2}^{13} + ⌊ \frac{{n}_{sf}}{{N}_{2}} ⌋ \cdot {2}^{9} + {N}_{ID}^{cell}$$

wherein: cᵢₙᵢₜ is an initial scrambling sequence, n_{RNTI} is a radio network temporary identifier, N_{ID}^{cell} is a cell identifier (ID), n_{sf} is a subframe index, and q is a codeword index; or generating an updated scrambling sequence for every N₂ subframes.

Example 40 includes the at least one machine readable storage medium of Example 38, wherein the instructions further perform: encoding, for transmission to a UE, a length of the N₂ consecutive subframes for QAM symbol level combination using a downlink control information (DCI) signaling or higher layer signaling.

Example 41 includes the at least one machine readable storage medium of Example 40, wherein the DCI signaling or the higher layer signaling is either UE-specific or cell-specific.

Various techniques, or certain aspects or portions thereof, may take the form of program code (i.e., instructions) embodied in tangible media, such as floppy diskettes, compact disc-read-only memory (CD-ROMs), hard drives, non-transitory computer readable storage medium, or any other machine-readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a random-access memory (RAM), erasable programmable read only memory (EPROM), flash drive, optical drive, magnetic hard drive, solid state drive, or other medium for storing electronic data. The node and wireless device may also include a transceiver module (i.e., transceiver), a counter module (i.e., counter), a processing module (i.e., processor), and/or a clock module (i.e., clock) or timer module (i.e., timer). In one example, selected components of the transceiver module can be located in a cloud radio access network (C-RAN). One or more programs that may implement or utilize the various techniques described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

It should be understood that many of the functional units described in this specification have been labeled as modules, in order to more particularly emphasize their implementation independence. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions, which may, for instance, be organized as an object, procedure, or function. Nevertheless, the executables of an identified module may not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Reference throughout this specification to “an example” or “exemplary” means that a particular feature, structure, or characteristic described in connection with the example is included in at least one embodiment of the present technology. Thus, appearances of the phrases “in an example” or the word “exemplary” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present technology may be referred to herein along with alternatives for the various components thereof. It is understood that such embodiments, examples, and alternatives are not to be construed as defacto equivalents of one another, but are to be considered as separate and autonomous representations of the present technology.

Furthermore, the described features, structures, or characteristics may be combined in any suitable manner in one or more embodiments. In the following description, numerous specific details are provided, such as examples of layouts, distances, network examples, etc., to provide a thorough understanding of embodiments of the technology. One skilled in the relevant art will recognize, however, that the technology can be practiced without one or more of the specific details, or with other methods, components, layouts, etc. In other instances, well-known structures, materials, or operations are not shown or described in detail to avoid obscuring aspects of the technology.

While the forgoing examples are illustrative of the principles of the present technology in one or more particular applications, it will be apparent to those of ordinary skill in the art that numerous modifications in form, usage and details of implementation can be made without the exercise of inventive faculty, and without departing from the principles and concepts of the technology. Accordingly, it is not intended that the technology be limited, except as by the claims set forth below.

What is claimed is:

1-20. (canceled)

21. An apparatus of a user equipment (UE) operable to provide coverage enhancement for unlicensed internet of things (IoT), the apparatus comprising:
one or more processors configured to:
decode, at the UE, data in a selected subframe received on a transmission on a physical downlink shared channel (PDSCH) received from a next generation node B (gNB);
decode, at the UE, a repetition number in time, a value of N, for the data received on the PDSCH from the gNB, wherein the value of N is a positive integer value; and
decode, at the UE, a repeated transmission received from the gNB, wherein the repeated transmission includes the data on N consecutive subframes; and
a memory interface configured to send to a memory the data received in the repeated transmission.

22. The apparatus of claim 21, wherein the one or more processors are further configured to:
identify, at the UE, the repetition number, wherein the repetition number is received via downlink control information (DCI).

23. The apparatus of claim 21, wherein the one or more processors are further configured to:
identify, at the UE, the repetition number, wherein the repetition number is received via radio resource control (RRC) signaling.

24. The apparatus of claim 21, wherein the one or more processors are further configured to:
decode, at the UE, a redundancy version (RV) for the N consecutive subframes with a selected scrambling sequence and a frequency resource.

25. The apparatus of claim 21, further comprising a transceiver configured to:
receive the repetition number for the data received on the PDSCH from the gNB.

26. The apparatus of claim 21, wherein the UE includes an antenna, a touch sensitive display screen, a speaker, a microphone, a graphics processor, an application processor, an internal memory, a non-volatile memory port, or combinations thereof.

27. An apparatus of a next generation node B (gNB) operable to provide coverage enhancement for unlicensed internet of things (IoT), comprising:
one or more processors configured to:
encode, for transmission on a physical downlink shared channel (PDSCH), data in a selected subframe;
encode, for transmission to a user equipment (UE), a repetition number in time, a value of N, for the data to be transmitted on the PDSCH, wherein the value of N is a positive integer value; and
encode the data on N consecutive subframes for repeated transmission of the data in the selected subframe to the UE; and
a memory interface configured to receive from a memory the data in the selected subframe.

28. The apparatus of claim 27, wherein the one or more processors are further configured to:
generate a scrambling sequence for N₂ consecutive subframes; and
set a value of N₂ equal to the value of N₁ to enable quadrature amplitude modulation (QAM) symbol level combination.

29. The apparatus of claim 28, wherein the one or more processors are further configured to:
generate the scrambling sequence using:
$${c}_{init} = {n}_{RNTI} \cdot {2}^{14} + q \cdot {2}^{13} + ⌊ \frac{{n}_{sf}}{{N}_{2}} ⌋ \cdot {2}^{9} + {N}_{ID}^{cell}$$
wherein: cᵢₙᵢₜ is an initial scrambling sequence, n_{RNTI} is a radio network temporary identifier, N_{ID}^{cell} is a cell identifier (ID), n_{sf} is a subframe index, and q is a codeword index.

30. The apparatus of claim 28, wherein the one or more processors are further configured to:
generate an updated scrambling sequence for every N₂ subframes.

31. The apparatus of claim 28, wherein the one or more processors are further configured to:
encode, for transmission to the UE, a length of the N₂ consecutive subframes for QAM symbol level combination using a downlink control information (DCI) signaling or higher layer signaling.

32. The apparatus of claim 31, wherein the DCI signaling or the higher layer signaling is either UE-specific or cell-specific.

33. The apparatus of claim 28, wherein the one or more processors are further configured to:
encode, for transmission to the UE, a redundancy version (RV) for the N consecutive subframes with a selected scrambling sequence and a frequency resource.

34. At least one non-transitory machine readable storage medium having instructions embodied thereon for providing coverage enhancement for unlicensed internet of things (IoT), the instructions when executed by one or more processors at a next generation node B (gNB) perform the following:
decoding, at the UE, data in a selected subframe received on a transmission on a physical downlink shared channel (PDSCH) received from a next generation node B (gNB);
decoding, at the UE, a repetition number in time, a value of N, for the data received on the PDSCH from the gNB, wherein the value of N is a positive integer value; and
decoding, at the UE, a repeated transmission received from the gNB, wherein the repeated transmission includes the data on N consecutive subframes.

35. The at least one non-transitory machine readable storage medium of claim 34, further comprising instructions that when executed perform:
identify, at the UE, the repetition number, wherein the repetition number is received via downlink control information (DCI).

36. The at least non-transitory one machine readable storage medium of claim 34, further comprising instructions that when executed perform:
identify, at the UE, the repetition number, wherein the repetition number is received via radio resource control (RRC) signaling.

37. The at least one non-transitory machine readable storage medium of claim 34, further comprising instructions that when executed perform:
decode, at the UE, a redundancy version (RV) for the N consecutive subframes with a selected scrambling sequence and a frequency resource.

38. The at least one non-transitory machine readable storage medium of claim 34, further comprising instructions that when executed perform:
generating a scrambling sequence for N₂ consecutive subframes; and
setting a value of N₂ equal to the value of N₁ to enable quadrature amplitude modulation (QAM) symbol level combination.

39. The at least one non-transitory machine readable storage medium of claim 38, further comprising instructions that when executed perform:
generating the scrambling sequence using:
$${c}_{init} = {n}_{RNTI} \cdot {2}^{14} + q \cdot {2}^{13} + ⌊ \frac{{n}_{sf}}{{N}_{2}} ⌋ \cdot {2}^{9} + {N}_{ID}^{cell}$$
wherein: cᵢₙᵢₜ is an initial scrambling sequence, n_{RNTI} is a radio network temporary identifier, N_{ID}^{cell} is a cell identifier (ID), n_{sf} is a subframe index, and q is a codeword index.

40. The at least one non-transitory machine readable storage medium of claim 38, further comprising instructions that when executed perform:
generating an updated scrambling sequence for every N₂ subframes.
